(19) United States
(12) Patent Application Publication
(10) Pub. No.: US 2011/0189056 A1
(43) Pub. Date: Aug. 4, 2011

(54) MICROWAVE REACTOR

(75) Inventors: James Hayden Brownell, Wilmington, DE (US); Stanislav V. Zhilkov, Philadelphia, PA (US); Valerie S. Zhylkov, Kharkov (UA)

(73) Assignee: ACCELBEAM DEVICES, LLC, Wilmington, DE (US)

(21) Appl. No.: 12/682,775

(22) PCT Filed: Oct. 9, 2008
(86) PCT No.: PCT/US08/11779

§ 371 Date: Jan. 25, 2011

Related U.S. Application Data
(60) Provisional application No. 60/998,542, filed on Oct. 11, 2007.
(60) Provisional application No. 60/998,543, filed on Oct. 11, 2007.
(60) Provisional application No. 60/998,500, filed on Oct. 11, 2007.

(51) Int. Cl. B01J 19/12

(52) U.S. Cl. 422/186

(57) ABSTRACT

A microwave reactor for processing a flow of a mixture, said reactor comprising a reaction chamber having an unpressurized interior and a reaction block disposed within the interior of the reaction chamber, with at least one antenna disposed within the interior of the chamber; and at least one generator of electromagnetic radiation connected to the antenna so that the flow may circulate through said reaction block, and the generator generates a radiation that is uniformly and homogeneously propagated in the chamber and is evenly absorbed by the mixture. The present invention provides embodiments of microwave reactors capable of processing reaction volumes normally found in early stage drug development and pre-clinical studies, as well as embodiments sufficient for commercial production, the designs disclosed incorporate process controls as well as high microwave field uniformity. The reactor may process batches, or may be a flow through design, or a ‘stop flow’ design whereby flow is admitted, a batch is processed and the flow is re-started.

This application is related to United States Provisional Patent Application Serial Nos. U.S. Patent Application No. 60/998,542, filed Oct. 11, 2007; U.S. Patent Application No. 60/998,543, filed Oct. 11, 2007; and U.S. Patent Application No. 60/998,500, filed Oct. 11, 2007, all of which are owned by the assignee of the present invention and are hereby incorporated by reference as though fully set forth.

### FIELD OF THE INVENTION

The present invention relates to electronic and electromechanical devices used for processing of chemical and biological samples that are to be exposed to microwave radiation. In particular, the invention is in the field of microwave power applications, applications include the electromagnetic heating of foods and other materials, etching of semiconductor devices in plasma reactors, chemical and biochemical processing including synthesis of pharmaceutical compounds, optimizing fuel production, producing ceramics, curing epoxy and composite materials, and other microwave-enhanced material processing.

### BACKGROUND OF THE INVENTION

The addition of energy is often required to initiate or accelerate chemical reactions and enhance non-chemical processes such as drying. It is known to place reagents in microwave-permeable reaction vessels and to place the vessels in a microwave chamber for irradiation with microwaves. Devices that are capable of processing reactions in batch form are sold, for one example, by CEM Corporation of Matthews, N.C. (USA) and devices that process reactions using microwaves in a continuous flow are sold by Milestone Microwave of Shelton, Conn. (USA).

Microwave Assisted Organic Synthesis (MAOS) is a tool used by medicinal chemists and similar disciplines to accelerate the speed of small scale chemical synthesis by 10-1000 fold. However, the presently available technology is not capable of controlling the microwave energy input into large volumes. This inefficiency limits the application of MAOS to the early discovery stage where the volumes processed are by nature very small. The potential advantage of being able to scale-up an MAOS reactor include: (1) consistent process protocols over all stages of drug development and API production; (2) faster drug development; (3) higher yield and reproducibility due to a uniform microwave field; (4) better process controls; (5) better supply chain management with just-in-time production; (6) reduced waste in terms of both energy and the product being processed; (7) higher energy efficiency; and (8) enhanced safety

It would therefore be desirable to have microwave reactors capable of processing reaction volumes normally found in early stage drug development and pre-clinical studies, as well as embodiments sufficient for commercial production.

### SUMMARY OF THE INVENTION

These and other shortcomings of the prior art are overcome by the present invention which, in preferred embodiments provides a microwave reactor for processing a flow of a mixture, said reactor comprising a reaction chamber having an unpressurized interior and a reaction block disposed within the interior of the reaction chamber, with at least one antenna disposed within the interior of the chamber; and at least one generator of electromagnetic radiation connected to the antenna so that the flow may circulate through said reaction block, and the generator generates a radiation that is uniformly and homogeneously propagated in the chamber and is evenly absorbed by the mixture. Preferably, the reaction chamber cross-section is symmetrical and more preferably the reaction chamber is cylindrical and the chamber cross-section is circular. In preferred embodiments the reactor comprises one antenna disposed on one side of the reaction block or two antennae disposed on opposite sides of a reaction block, or in alternate embodiments comprises one an array of antennae disposed on one side of the reaction block. In certain embodiments, the reactor comprises at least two arrays of antennae disposed on opposite sides of a reactor block. The reaction block is preferably comprised of a solid section of material comprising one or more reaction channels within the solid section of material, and the reaction channels comprise one or more tubular channels. The reaction block has either a planar or a non-planar surface profile, chosen from the group consisting of concave or convex, wherein the surface profile is selected to refract the microwave field to produce a uniform within the reaction channels. In preferred embodiments, a plurality of cooling channels disposed adjacent the reaction channels are provided. The reaction block can be constructed of one or more tubes connected to a manifold and the tubes are either disposed entirely within the reaction chamber, or partially outside the chamber. The reaction block can have one or more inlets for admitting flow through a wall of the chamber. In preferred embodiments, the reactor further comprises one or more computer controlled valves for regulating the operation of the reactor.

Additionally, the present invention also provides embodiments of a microwave reactor for processing a batch of a mixture that ahs the features of the flow and stop-flow embodiments.

The present invention thus provides embodiments of microwave reactors capable of processing reaction volumes normally found in early stage drug development and pre-clinical studies, as well as embodiments sufficient for commercial production, the designs disclosed incorporate process controls as well as high microwave field uniformity. The reactor may process batches, or may be a flow through design, or a ‘stop flow’ design whereby flow is admitted, a batch is processed and the flow is re-started.

### BRIEF DESCRIPTION OF THE DRAWINGS

FIG. 1 is an elevation end view of a first embodiment of a microwave reactor assembly made in accordance with certain aspects of the present invention;

FIG. 2 is a side elevation view of the microwave reactor assembly shown in FIG. 1;

FIG. 3 is a perspective view of a vessel block;

FIG. 4 is a perspective view of an alternative vessel block design;

FIG. 5 is a top plan view of a reactor vessel made in accordance with the present invention;

FIG. 6 is a top plan view of an alternate design of a reactor vessel made in accordance with the present invention;

FIG. 7 is an elevation view of a second embodiment of a microwave reactor assembly made in accordance with the present invention;

FIG. 8 is an elevation view of an alternate embodiment of a microwave reactor assembly;

FIG. 9 is an elevation view of another embodiment of a microwave reactor assembly made in accordance with certain aspects of the present invention;

FIG. 10 is a schematic illustration of the flow of pressurizing gas to a microwave reactor made in accordance with the present invention;

FIG. 11 is an illustration of a clamping mechanism used to secure the lid of a microwave reactor made in accordance with the present invention;

FIG. 12 is an illustration the clamping mechanism shown in FIG. 11 when fully locked; and

FIGS. 13A-13B are an illustration of an alternative clamping mechanism used to secure the lid of a microwave reactor made in accordance with the present invention.

### DETAILED DESCRIPTION OF THE PREFERRED EMBODIMENTS

Although the features and elements of the present invention are described in the preferred embodiments in particular combinations, each feature or element can be used alone (without the other features and elements of the preferred embodiments) or in various combinations with or without other features and elements of the present invention.

As used herein “microwave reactor” includes, but is not limited to, a mechanical or electromechanical or all electronic device. As used herein, “microwave” includes all electromagnetic frequencies useful for material processing, primarily spectral ranges from radio frequency (RF, approximately 100 MHz minimum) to about 10 THz. As used herein “generator” might be a magnetron, a klystron, a gyrotron, or other microwave generator.

The present invention discloses a plurality of planar antennae operating in one or more frequency band. The exact arrangement of antennae depends on the shape of the vessel and chamber. The design of the antennae or antennae arrays set forth below is well within the ambit of those of ordinary skill in the art to design, test and implement without undue experimentation.

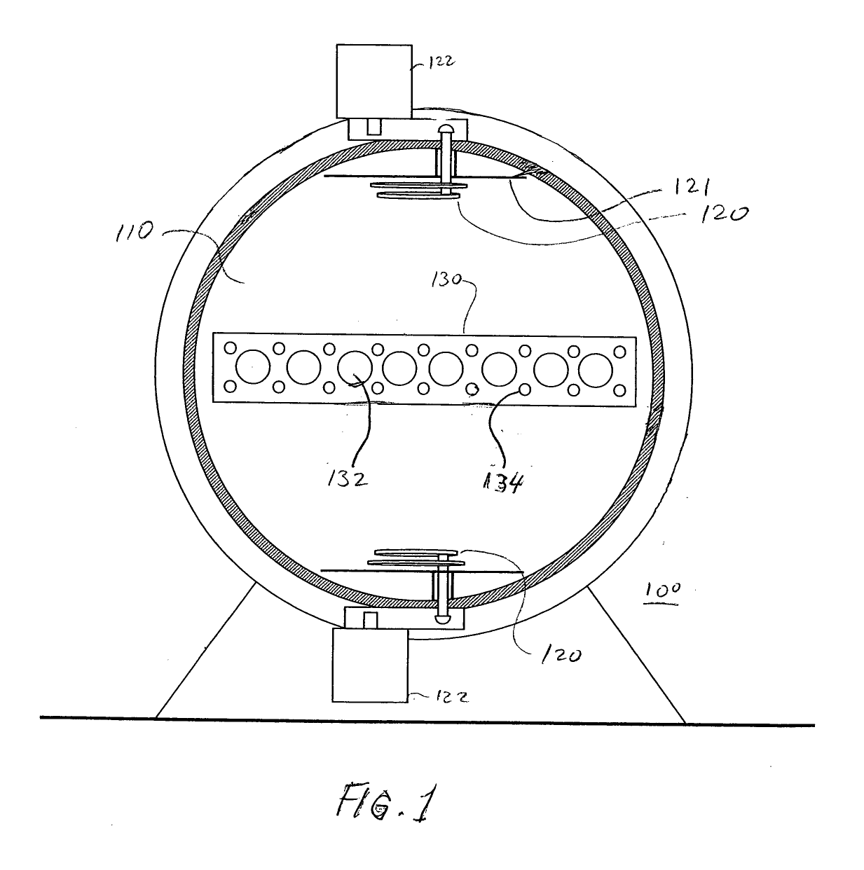

Referring now to FIG. 1, there is shown a first embodiment of the present invention, a microwave reactor 100 that is particularly well suited for scale-up flow-through and stop-flow processing. As discussed below with reference to other embodiments of the present invention, the design disclosed is optimal for certain volumes of reactor vessels but is not necessarily limited to these volumes, nor is the design limited to particular power levels, temperatures or pressures. As will be understood by those familiar with the design and construction of these devices, advancements in materials and control technologies permit an endless number of variations as the design disclosed is scaled from the smallest reaction vessel to the largest.

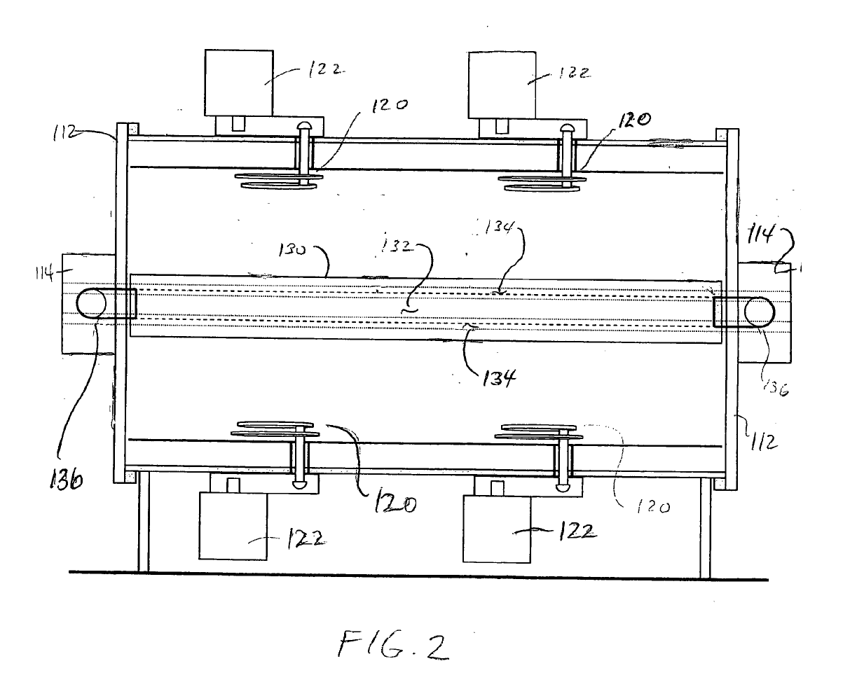

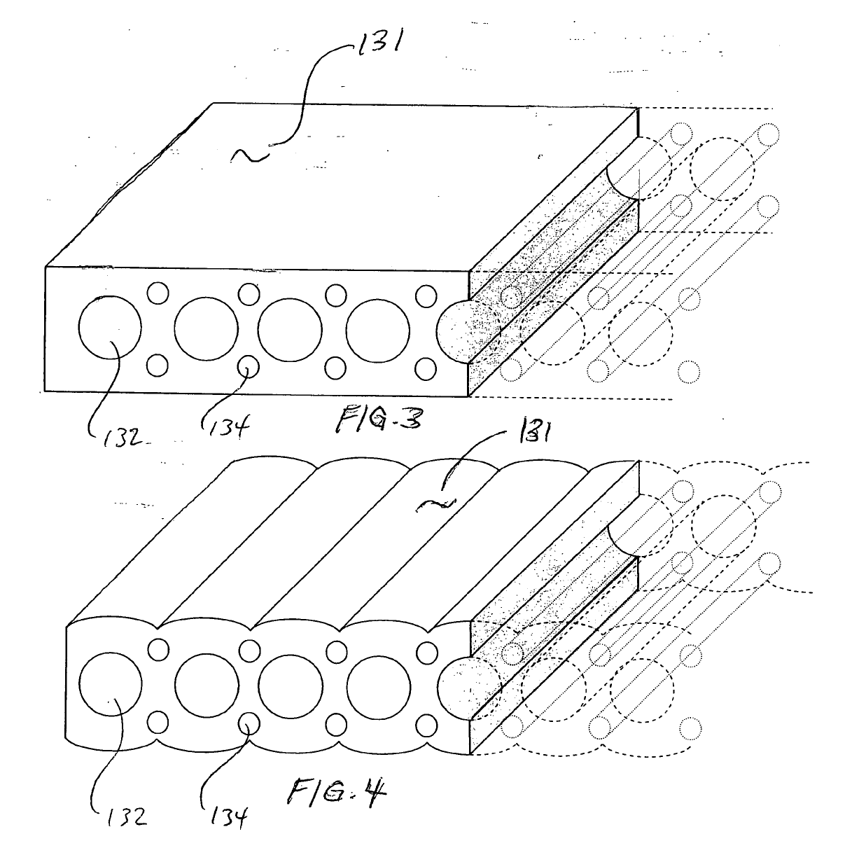

In a preferred embodiment, seen in the cut away end view elevation in FIG. 1 and a cross-section side elevation in FIG. 2, a reactor 100 is comprised of an unpressurized microwave chamber 110 encompassing a microwave transparent vessel. One or more microwave antennae 120 distribute microwave radiation created by one or more magnetrons 122 over a vessel 130, preferably from both sides, and most preferably as uniformly as possible. Typically, a conductive backplane with coax shield 121, which may or may not be perforated is disposed between the antenna 120 and the walls of the chamber 110. In the embodiment illustrated, the vessel 130 is an array of flow channels 132 and cooling channels 134 designed to achieve optimal processing. The reactor 100 can be operated in either flow-through or stop-flow modes with minimal additional supporting systems. Post-processing rapid cooling can be done either within the vessel 130 or in a stage after the material being processed exits the chamber 110. This design disclosed herein is compact and simple to make, maintain and operate. As noted above, scaling the design and increasing the reactor capacity is relatively easy to effect as well.

A side view of the reactor 100 shown in FIG. 1 is illustrated in FIG. 2. In the embodiment illustrated, it is seen that there are four antennae 120 as described above. Four separate magnetrons 122 are also shown, but it will be understood that in certain embodiments, less than one magnetron 122 per antenna 120 can be employed. As also seen in FIG. 2, the chamber 110 is sealed by two endplates 112. The cooling channels 134 extend through the endplates 112, through an insulator block 114 to permit cooling fluid to flow through the vessel block 130. The mixture channels 132 similarly flow through the endplates 112 and through tubing bends 136 that permit mixture flow as described below. The tubing bends 136 are separate from but sealed with the vessel block 130 so that the latter can be replaced or switched as need be when the end plates 112 are removed.

Referring now to FIGS. 3 and 4, there is shown a cross-section, in perspective, of a vessel block 130 that is used in the reactor design illustrated in FIGS. 1-2. The vessel block 130 may be rectangular in cross-section as shown or can be shaped to conform to the walls of the chamber 110. The vessel block 130 includes mixture channels 132 and coolant channels 134, as described above, and is preferably made of microwave transparent material that can hold high pressure and conduct heat, which is also a material that is not chemically reactive. In one embodiment, the channels 132 are a continuous Teflon tube is inserted through a block and manifold (as described below) to isolate the mixture. Then tube is replaced instead of the entire block when it becomes dirty. The channels 132 (or the opening that receive a tube) can have a circular or elliptical or other cross-section. As seen by comparing FIG. 3 with FIG. 4 the surface 131 can be a planar surface or can be shaped to concentrate and focus the microwave power on the mixture channels, depending on the dielectric properties of the vessel.

Typically, the vessel load volume is limited by the penetration depth of the processed mixture. Circular channels extending the entire chamber length are preferably spaced about one diameter apart, plus an additional distance “X” (where distance X provides sufficient material for mechanical strength to withstand typically up to 350 psi although higher pressures will be accommodated in certain embodiments) over the entire chamber width. The number of channels is N=W/(2R+X). The total irradiated volume is then V=pR̂2 L N. If X can be small compared to R, then V is proportional to R, and therefore wavelength, as well as chamber area (W L), independent of whether the channels are oriented lengthwise or widthwise. The volume can be increased by increasing L and N (i.e. width) and the wavelength.

In a flow plate such as the vessel block 130 illustrated, the fluid speed S, the flow rate F and processing time T are respectively F=□pR̂2SN and T=L/S in parallel format or F=□pR2S and T=NL/S in serial format. The product of flow rate and processing time equals the volume (V=FT), and is independent of channel configuration. Inversely, the processing rate (i.e. flow rate) is generally F=V/T in either flow-through or stop-flow mode. Therefore, to achieve sufficient processing rate, the volume must be large enough for a given processing time. The chamber area and wavelength should be chosen accordingly. The microwave antenna system would then be designed to irradiate the entire vessel uniformly with sufficient microwave intensity to drive the process at its optimal rate.

For one example for a particular embodiment that is by no means limiting, given R=D=1.5 cm at 2.45 GHz microwave frequency, and choosing W=50 cm, L=100 cm, and X=1 cm, then N=12 and V=8 liters. If the processing time is T=1 min, then the fluid speed is S=12 m/min (in serial configuration) and the processing rate is F=8 L/min. A minimum 1 L/min in stop-flow mode and 10 L/min in flow-through mode is typical for commercial reactors, although the present invention is not limited to these flow rates. Employing microwave radiation at a frequency of about 915 MHz allows R=D˜4 cm, or 2.5 times the irradiated volume in a given chamber, with a resulting flow rate of F=20 L/min.

As seen by comparing FIGS. 3 and 4, the vessel block 130 can be designed in several ways depending on material and channel configuration. The position of the vessel block 130 is chosen to optimize vertical homogeneity of absorption or intensity of the microwave intensity over the processed material volume. In certain embodiments a solid block of microwave transparent material with straight channels extending through it (as shown in FIGS. 3 and 4). The block 130 may have flat external surfaces, for simplicity in manufacture and calculating the microwave field distribution, as seen in FIG. 3 or shaped profiles to refract the fields in a desired pattern, such as to produce a more uniform microwave intensity within the channels, as seen in FIG. 4. The channels 132,134 are included for either transporting the processing mixture 132 or a fluid coolant 134. The primary channels 132 for carrying the processing mixture may have a circular cross-section, for ease in manufacture, or other shape to achieve better performance such as uniformity of microwave absorption. Secondary channels 134 are optionally included to carry microwave transparent coolant (as shown in FIGS. 3 and 4). If the secondary channels 134 are omitted, cooling would occur in a post processing stage outside of the microwave chamber 110. The material and channel configuration would allow for the vessel block 130 to hold high pressure in the primary channels 132. The coolant channels 134 and chamber 110 are preferably maintained at or near atmospheric pressure.

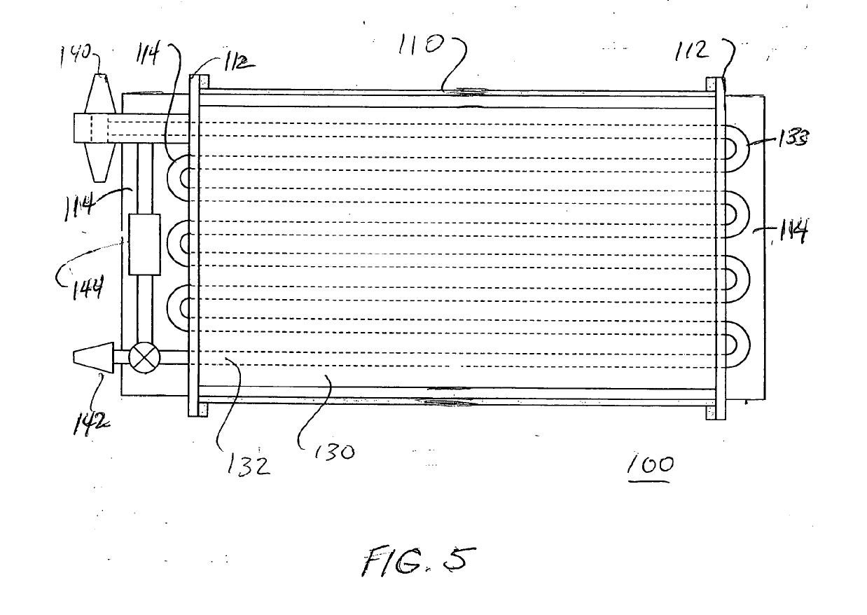

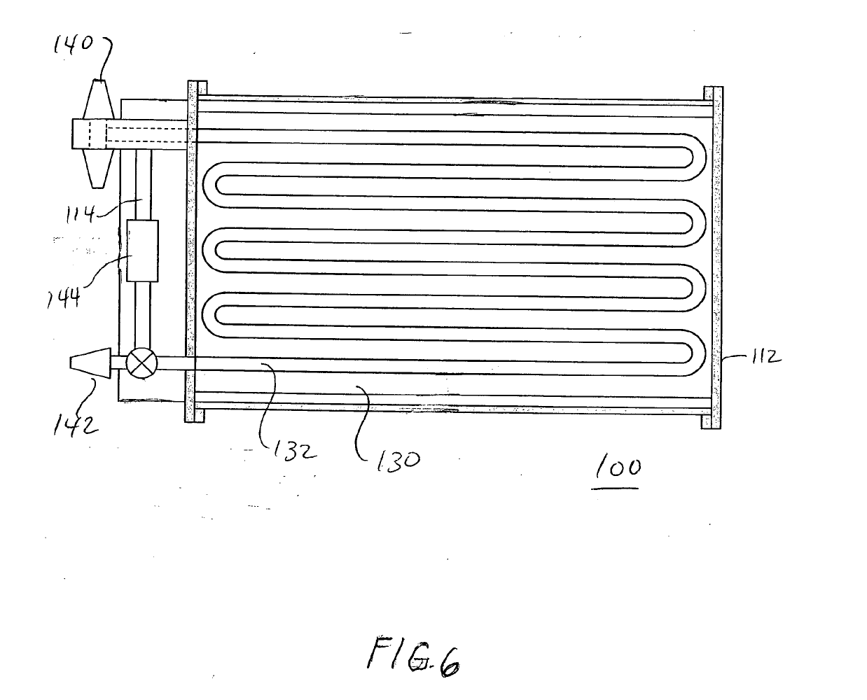

Referring now to FIG. 5, in another embodiment, the mixture channels 132 are formed by microwave transparent tubes, which have an external “U” shaped bend 133 at each end. The tubes 132 are preferably be embedded in a microwave transparent matrix, sealed to the bends 133 that are in turn welded to the endplate 112, thereby forming a vessel block 130 substantially as described above. Cooling occurs in a post processing stage outside of the microwave chamber, unless coolant tubes are incorporated in the matrix, or a combination of the two methods can be used. In yet another embodiment, the mixture channel tubing 132 is joined into continuous and seamless pipe snaking throughout the chamber without extending out of the chamber at each turn, as shown FIG. 6. To provide strength, if necessary, the tubes would be preferably embedded in a microwave transparent matrix, forming a vessel block 130 similar to that illustrated in FIGS. 3-4. Cooling occurs in a post processing stage outside of the microwave chamber unless coolant tubes are incorporated in the matrix, or a combination of the two methods can be used. Also visible in FIG. 5 is the double inlet pressure valve 140 for admitting two components directly, and the back pressure valve and outlet 142 for cooled processed liquid. For stop-flow mode, the mixture directed to the inlet 140. For flow-through mode, cooling liquid would only be directed to this end. The flow is created and controlled by a pump 144 and its associated electronics. In another embodiment, in the absence of any embedding matrix, cooling within the chamber 110 using a structure similar to that shown in FIGS. 3 and 4 is achieved by submerging the mixture tubes 132 in a microwave transparent fluid coolant. The coolant is contained in a microwave transparent tank surrounding the tubes. The channels are connected either in series, parallel, or possibly in parallel series groups, by manifolds integrated into the endplates of the chamber. These manifolds may be simple tubes as shown in FIGS. 3-6, or are in certain embodiments more complex structures to achieve the desired mixture flow pattern. Temperature sensors and agitators (e.g. ultrasonic or passive vanes) could be implemented in the manifolds to monitor mixture temperature and provide stirring during processing. The manifolds would be insulated to prevent heat loss during processing. The vessel and manifolds would either be made of non-reactive material or coated with a non-reactive material such as Teflon, PEEK, sapphire, diamond or glass.

The advantage of designing the vessel block 130 as described herein is simplicity in fabrication and installation in the chamber 110. The chamber 110 is made of standard components: cylindrical chamber 110 (with mounted antennae 120), two endplates 112 (with plumbing fixtures) as seen in FIG. 2, and vessel block 130. High pressure seals are formed by pressing the stainless steel tubing, welded into the endplates 112 and with elastomer o-rings mounted on the stems, into the channels in the vessel block 130. These seals allow for differential thermal expansion. Maintenance is done by removing one endplate and then pulling out vessel block 130. Operation requires electrical feed and cooling water, depending upon the capacity of the reactor and the velocity of the flow . The vessel block 130 and endplates 112 could be replaced as needed or a set could be used specifically for each process.

Typically, in the vessel shown in FIGS. 1-6 the volume in the mixture channels 132 would not be irradiated; this volume is typically relatively small in the embodiment shown in FIG. 3. However, the design can be optimized if desired. In flow-through mode, all parts of the mixture will be exposed to the same conditions over the entire process. So long as the flow rate is of sufficient velocity, those skilled in the art will appreciate that active stirring is unnecessary. Appropriately designed passive mixing elements in the manifolds and/or microwave permeable passive mixing elements in the channels achieves sufficient mixing. In stop-flow mode, active stirring is done by actuators in the manifolds.

Stop-flow processing can be implemented by circulating mixture through the block in a closed loop. One or more valves can be used to direct flow in a circulatory manner through a pump and back to the vessel when stop-flow processing is desired. Alternatively, stop-flow processing can be done in a non-circulating geometry, requiring active mixing elements to achieve mixing, by closing upstream and downstream valves controlling flow through the vessel. The valves could be activated to choose between stop-flow and continuous flow-through processing modes. The pump operates at high pressure but only produces a low differential pressure to produce sufficient flow rates. Passive mixing elements are optionally installed in the manifolds to cause mixing as the fluid flows passed them (not illustrated). It will be appreciated by those of skill in the art that the plumbing and pump can in certain embodiments be difficult to maintain and clean and this should be taken into consideration when designing the system.

The chamber 110 may be cylindrical with circular, elliptical, rectangular or some other cross-section depending on the requirements for strength against vessel failure and microwave intensity distribution. The chamber axis and the vessel are preferably but not necessarily oriented horizontally to minimize convection and thermal gradients.

The pressure of the mixture undergoing processing is preferably maintained by adjustable pressure regulating valves at the input and outlet of the vessel. Typically multiple components that don't mix well are injected directly into the vessel. For this purpose, as illustrated in FIGS. 5 and 6, two or more input valves 150,152 could be installed. Pumps in each input line prior to the valves 150,152 maintain sufficient pressure for valve control. In stop-flow mode, in order to maintain pressure during heating, mixture can be released through the in-line outlet valve or through a second outlet valve into an unprocessed waste line.

Temperature is controlled by modulating the microwave power in response to feedback provided by temperature sensors installed in the manifolds. For example, the sensors could be model number FTP-ALO or FTP-PEEK probe offered by Photon Control of Burnaby, BC Canada. Because magnetron microwave sources require several minutes to stabilize, electronically controlled ferrite attenuators are preferably installed to provide approximately real-time repeatable power adjustment. This is important because microwave-assisted reaction times have been measured or speculated to be faster than one minute.

The rapid cooling required in the various embodiments is also a design consideration. In stop-flow mode, if coolant circulates through the vessel block, then rapid cooling can be done following processing while the mixture circulates through the vessel block. Once the processed mixture is cool enough (i.e. below the boiling point of all important components), it is pushed out of the vessel by pumping in the next vessel charge. However, in flow-through mode or if no coolant circulates within the vessel block, the processed mixture can be released by a pressure regulating valve into a chamber preferably although not necessarily with internal or surrounding cooling coils that may also achieve cooling by a Joule-Thomson process, i.e., expansion through a valve. This chamber is in certain embodiments filled with mixture from the previous processing run. Any initial evaporation is condensed again as the cooling chamber pressure quickly builds and as the mixture cools.

In certain embodiments, spectroscopic monitoring of the reaction progress is preferably but not necessarily implemented through optical fibers mounted in the manifolds. For example, Photon-Control and Ocean Optics of Dunedin, Fla. (oceanoptics.com) offers very compact fiber coupled UV-Vis, Vis-NIR and Raman spectrometer systems for chemical analysis. RF spectroscopy is implemented by modulating the microwave carrier, or even introducing a separate signal, in order to induce a response in the mixture that is picked up by an antenna.

Additionally, in certain embodiments, electromagnet coils are incorporated into the chamber in order to induce nuclear magnetic resonance (NMR) signals for chemical identification. Alternatively, a small volume could be extracted continuously during processing and fed through an NMR unit for real time analysis of the process progress.

Suitable microwave transparent materials may be PEEK (PolyEtherEtherKetone), Teflon, PTFE, Polyethylene, Polypropylene, Pyrex, quartz, sapphire etc. PEEK is machinable, chemically inert and resistant, used in autoclaves, rated to 260 C, and survives 3000+ sterilization cycles.

In preferred embodiments, a reactor system made in accordance with the present invention is equipped with one or more of the following diagnostic and control features. Diagnostic indicators would include real-time sensing of the chamber pressure, mixture temperature (at one or more points), rate of stirring, delivered microwave power, and spectroscopy (for example, UV-Vis absorption and/or Raman). All sensor information is then preferably but not necessarily recorded at user defined intervals and displayed graphically and as text, in combination or separately. Microwave distribution is certified so that absorbed microwave power density can be inferred. Data are preferably streamed to computer memory so that a record of all process conditions is available for future reference. In terms of control, the user control interface could consist of a ‘Prepare’, ‘Start’, and ‘Emergency Stop’ buttons and a keypad for entering all necessary parameters. The ‘Emergency Stop’ function is triggered if the handle is moved during processing (breaking an interlock), or pressure changes drastically, or the over-pressure valve opens, or coolant pressure drops, or any sensor malfunctions. The user could select the level and rate of change (1st derivative) of chamber pressure, mixture temperature (at one or more points), rate of stirring, and delivered microwave power over an essentially unlimited sequence of time intervals of arbitrary length. All of the diagnostic information would be used to control and stabilize the process conditions through proportional-integral-differential (PID) algorithms. Pressure must be released in a safe manner.

It has been found that a comparison of diagnostic curves reveals that internal energy released due to the chemical reaction itself could be distinguished from heating directly due to microwave energy absorption. Such a comparison would help in understanding the dynamics of processing and selection of optimal parameters.

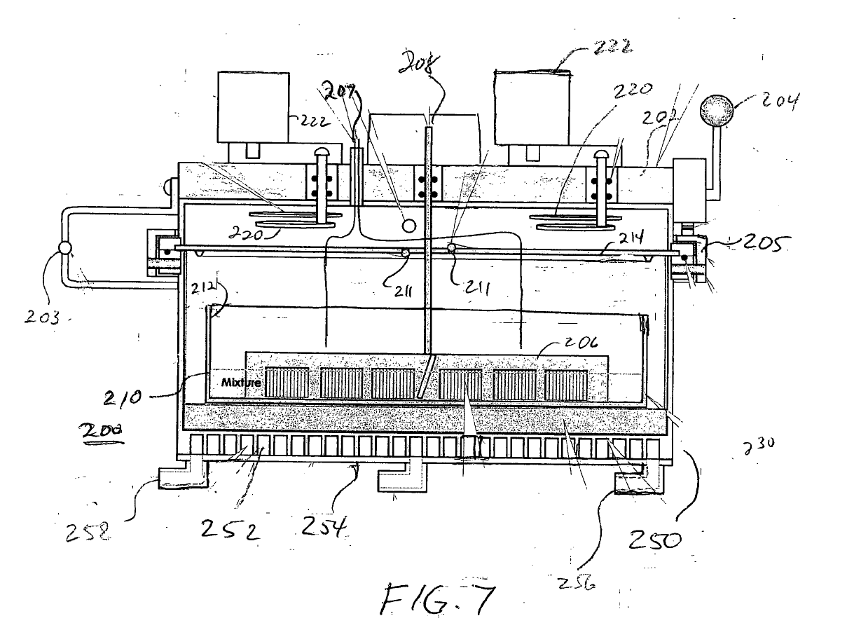

Referring now to FIGS. 7-8 an alternate embodiment of a reactor design made in accordance with the present invention is illustrated. This embodiment is a “batch” design and is particularly well suited for discovery and pre-clinical applications in the pharmaceutical industry, particularly for batches ranging in volume from 50 mL to 10.0 L. However, as mentioned above, any of the particular embodiments disclosed herein are not necessarily limited to a particular power range, vessel size, temperature or pressure limit and in particular are not necessarily industry specific.

The reactor 200 shown in FIG. 7 is comprised of a pressurized cylindrical chamber 210 with axis oriented vertically. A cut away side elevation view is illustrated. The reactor 200 is loaded by operating and lifting the locking handle 204 and opening the lid 202, which pivots about a hinge point 203 and when the reactor is open inserting a microwave transparent vessel 230 loaded with the mixture to be processed. A microwave antenna 220 mounted in the lid distributes the microwave radiation form a magnetron 222 uniformly over the chamber volume. In the embodiment shown there are two magnetrons 222 each coupled to its respective antenna 220. However, other embodiments may have only one magnetron (or more than two) and may have three or more antennae. As used herein “antenna”, “antennae” and “array” are not meant to be limiting and an “array” may have one or more antennae elements or a single antenna may be considered an array. In this embodiment, an optical fiber feed through 207 for spectroscopy and temperature measurement is provided, data from which may be used to operate and regulate the system Thus, pressure and temperature are controlled independently. Cooling during and after processing is done in situ. This design is compact and is simple to make, maintain and operate. Increasing the reactor capacity is relatively easy to effect based on the original design.

As seen above with reference to FIGS. 1 and 2, the chamber is a preferably right cylinder with flat or curved profile floor and ceiling. The cross-section may be circular and ceiling and floor profile elliptical for better strength to weight ratio or another shape. The chamber dimensions and microwave antenna design are chosen to optimize microwave intensity over the chamber volume where the processed material resides. Vertical vanes (ribs) could be welded to the floor and ceiling to provide sufficient mechanical strength and rigidity under maximum operating pressure in the chamber. Cooling coils 250 are welded to or machined into the floor, as seen in FIG. 7. Coolant is circulated in the coils 250 after processing to rapidly cool the processed mixture to below its boiling point at one atmosphere before extraction; coolant could be heated or drained (forced by pressurized gas) from the coils 250 during processing to influence the mixture temperature. As the chamber 210 should not become hot the touch, the chamber floor and coils 250 are designed for (a) minimal thermal conductivity with the mixture inside during processing in the absence of coolant in the coils and (b) maximal thermal conductivity with coolant filling the coils. The bottom exterior of the chamber may also include vanes to be air cooled during processing when the coils are drained.

In the embodiment shown in FIG. 7, to reduce evaporation, to protect chamber from corrosion and to ease cleaning, a removable liner 212 of thin, robust (thermally and chemically), microwave transparent plastic is inserted in the lower half of the chamber 210 and a removable, microwave transparent, rigid disk (barrier) 214 is snapped onto the lid 202, thereby covering the antennae 220. The barrier disk 214 presses on the rim of the liner 212 when the chamber lid 102 is closed, forming a hermetically sealed container within the chamber 210 that does not significantly degrade the homogeneity of the microwave field. The rigid barrier disk 214 presses on liner rim when closed, and creates a low point in center to direct splashes and condensation back into vessel, while a rim lip to stop drips. Orifices 209 covered by plastic, spring-loaded caps or spheres on either side of the lid ensure the vessel interior is maintained within a nominal pressure difference (a few psi) relative to the chamber 210. Several orifices 209 or a large orifice, higher pressure threshold relief valve are added in certain embodiments to prevent possible over-pressure of the vessel 200 due to valve failure. Note that presence of the liner 212 and barrier disk 214 should not significantly affect the microwave intensity distribution or the pressure distribution within the chamber 210.

The vessel 230 is any of a number of designs, such as a standard beaker (Pyrex or quartz or plastic) or other microwave transparent, flat bottomed container with diameter up to the diameter of the floor (or size that is the size of the floor regardless of shape) and with height sufficient to prevent spilling and with a large mouth. In order to avoid extreme microwave intensity gradients vertically within the mixture, the depth of the mixture should not be greater than the penetration depth of the mixture, typically 1.5 cm at 2.45 GHz and 4 cm at 915 MHz. A cylindrical chamber diameter of 40 cm would then provide a maximum mixture volume of 2 litres and 5 litres respectively. In order to maintain intensity [or absorption] homogeneity vertically through the vessel 230, the vessel 230 should be positioned at an optimal height corresponding roughly to an anti-node of the microwave field. Correct positioning of the vessel height is achieved by placing the vessel either on the liner 212 in the bottom of the chamber 210 on a microwave transparent, thermally conductive slab underneath the liner 210, filling the region between the chamber floor and vessel bottom, or on a thin, electrically isolated, metal disk placed on top of the liner 212, which must be thick enough to prevent breakdown between the disk and the chamber floor. The chamber floor, slab, liner and vessel most preferably have high thermal conductivity for rapid cooling. In certain embodiments, a small amount of microwave transparent fluid placed in the bottom of the chamber and the liner would improve thermal conductivity. Alternatively, the chamber 210 could be coated with a non-reactive, microwave transparent film, such as Teflon® to allow the chamber bottom to be used as the vessel. A further alternative is that the vessel 210 could be a flexible microwave transparent, sealed container (i.e., a bag) with a plugged spout. Preferably, the plug has pressure relief valves similar to that described above for the barrier disk 214, and in such an embodiment, the barrier disk 214 would not be necessary. During processing, the container would be over-pressured relative to the chamber 210 and therefore fully inflate. Orifices 211 covered by plastic, spring-loaded caps or balls on either side of the lid ensure the vessel interior is maintained within a nominal pressure difference (a few psi may be sufficient) relative to the chamber. The container would be lifted out of the chamber after processing and drained through the spout. Temperature and spectroscopy are sensed through the container wall via the port 207 described above or the spout is attached to a plug incorporating the temperature and spectrometer probes, so that the probes are inside the container during processing. The container 210 is preferably placed on a microwave transparent or metallic plate in the chamber 210 that has a contoured profile and moves, possibly chaotically, in order to effectively mix the container contents. In certain embodiments, the plate rises during processing and lowers to make thermal contact with the cooling mechanism in the floor. In a further alternative several beakers are processed simultaneously and a microwave absorbing fluid bath added in the bottom of the liner for more uniform heating.

As noted above, the embodiment of a reactor 200 made in accordance with the present invention illustrated in FIGS. 7 and 8 is intended for batch mode operation. The chamber 210 is opened by turning the handle 204 and lifting the lid 202, which in turn operates a rack and pinion and clamp ring 205 that act as a sealing mechanism, described in further detail below. The liner 212 and barrier disk 214 are cleaned or replaced as necessary. An uncovered, charged vessel 230 is placed on the chamber floor. An appropriate, clean stirring structure 206 is snapped onto the stirring axle 208, its associated motor, and the sensors are positioned for the vessel 210 to be processed. Preferably, the stirring rod 208 acts as a mechanical coupling rod, and is comprised of a metallic material for a coaxial cavity. In one preferred embodiment, a TFE stirring paddle 206 that is asymmetric for better stirring is used. The paddle 206 snaps on to glass stirring axle 208 and is replaced for each batch processed with correct size for the vessel being used. In other embodiments, magnetic stirring alternative may be employed, as known in the art. Magnetic stirring motor(s) are attached to the bottom of the reactor and magnet stir bars are placed in vessel. For large area vessels, an array of stir bars would be employed.

To process a batch, the lid 202 is closed and the handle 204 is turned until a safety interlock is set. The chamber pressure is increased to the desired processing value while the magnetron source 222 is allowed to reach stable operation. Microwave power is modulated to maintain the mixture at the desired temperature time profile. After processing, the mixture temperature is reduced sufficiently by circulating coolant in the cooling coils 250. Chamber pressure is reduced to atmosphere. The handle 204 is turned, lid lifted, and the vessel 210 is removed. In the embodiment shown, cooling channels 252 are milled into chamber floor and also serve as strengthening ribs, a plate 254 secured to bottom to contain coolant. The coolant inlet 256 and the coolant outlet 258 permit coolant to flow through the structure. The coolant inlet 256 is preferably positioned in the center of the reactor bottom plate and channels designed to direct coolant flow symmetrically outward to ensure more uniform conditions. Alternatively, the inlet 256 and outlet 258 are positioned on the on the side of the reactor so as not to interfere with magnetic stirring motors described above. The cooling components are preferably made from a material such as aluminum. Operation requires electrical (possibly near 10 3 kW), high pressure gas (possibly inert or combined with reagents), and cooling water (possibly 50 psi, 4 L/min, unless a closed circuit chiller is used) utilities.

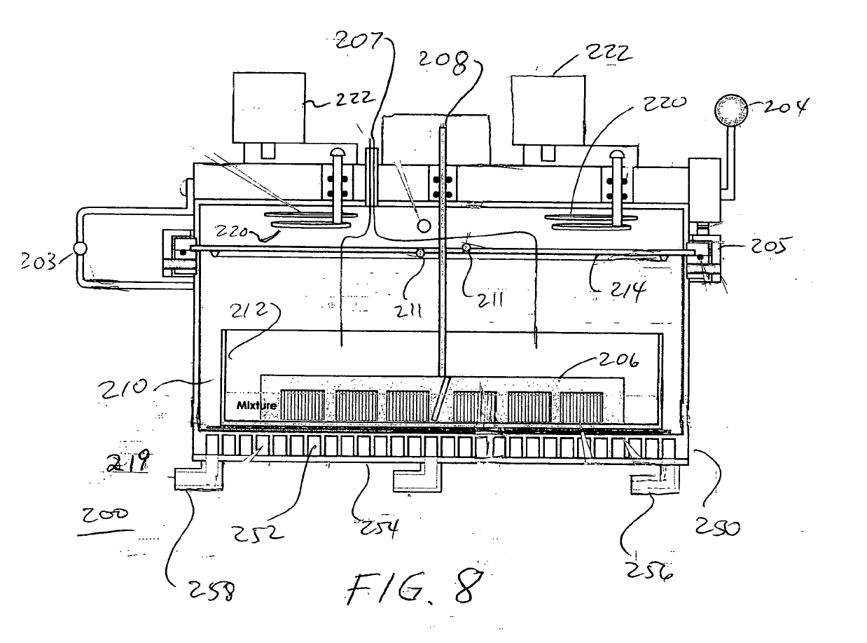

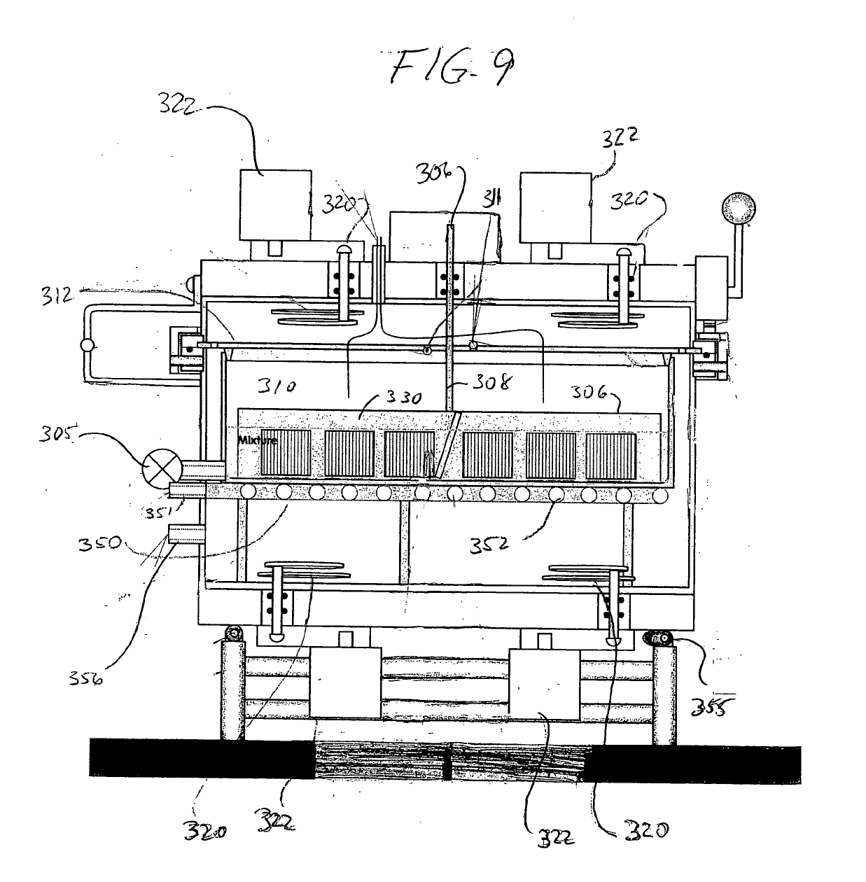

Finally, referring to FIGS. 9 and 10, yet another alternate embodiment of the present invention is illustrated. This embodiment is a “stop-flow” design and is particularly well suited for pre-clinical and clinical applications in the pharmaceutical industry, and in particular for processing between about 2 L and 10 L of mixture. However, as mentioned above, any of the particular embodiments disclosed herein are not necessarily limited to a particular power range, vessel size, temperature or pressure limit and in particular are not necessarily industry specific. Referring now to FIG. 9, a side view elevation of an embodiment of a stop-flow reactor 300 made in accordance with the present invention is illustrated. The illustrated embodiment shares many of the components and features of the other embodiments of the present invention illustrated and described above with reference to FIGS. 1-8 and these descriptions will not be repeated. The reactor 300 is comprised of a pressurized cylindrical chamber 310 with axis oriented vertically. The reactor 300 is loaded by a valve controlled inlet port 305 directing the mixture to be processed into a microwave transparent vessel 330 mounted inside the chamber 310. One or more microwave antenna 320 mounted in the lid 302 and the floor distribute microwave radiation created by the magnetrons 322 uniformly over the vessel volume. Pressure and temperature are controlled independently, using controls known in the art. Post-processing rapid cooling is done by coiling coils or on extraction from the vessel through an outlet port. The design illustrated in FIG. 9 is compact and is fairly simple to make, maintain and operate. Increasing the capacity of the reactor is relatively easy based on the design disclosed. The chamber 310 is preferably a right cylinder with flat floor and ceiling. The cross-section is preferably circular for better strength to weight ratio, although other shapes may be used. As explained above, the chamber dimensions and microwave antenna design are chosen to optimize microwave intensity and homogeneity over the middle height cross section of the chamber where the materials to be processed are disposed. Vertical vanes (ribs) are preferably welded to the floor and ceiling to provide mechanical strength and rigidity under the stresses encountered from the operating pressure in the chamber.

The vessel 330 may be made of glass (Pyrex or quartz) or other microwave transparent plastic with diameter up to the diameter of the floor. The vessel 330 is placed on a microwave transparent base to hold the mixture at an optimum height for microwave intensity [or absorption] homogeneity in the chamber 310. In order to avoid extreme microwave intensity gradients vertically within the mixture, the depth of the mixture should not be greater than twice (given irradiation from both sides) the penetration depth of the mixture, typically around 3 cm at 2.45 GHz and 9 cm at 915 MHz. A chamber diameter of 40 cm would then allow a maximum mixture capacity of 3 litres and 9 litres respectively. Scaling up further, a diameter of 75 cm has 12 or 36 litre capacity.

To reduce evaporation, a removable, microwave transparent, rigid disk (barrier) 312 is snapped onto the chamber 310, as described above. The vessel height is such that the barrier disk 312 presses on the rim of the vessel 310 when the chamber lid 302 is closed, forming a hermetically sealed container within the chamber 310 that does not significantly degrade the homogeneity of the microwave field. Orifices 311 covered by plastic, spring-loaded caps or balls on either side of the lid ensure the vessel interior is maintained within a nominal pressure difference (a few psi may be sufficient) relative to the chamber. Note that presence of the barrier disk 312 should not significantly affect the microwave intensity distribution or the pressure distribution within the chamber. Pressure is regulated via a pressurizing gas inlet/outlet 311.

Post-processing rapid cooling of the mixture is preferably achieved by extraction of the mixture under pressure from the vessel into a cooling stage 350 possibly by the Joule-Thomson process. Alternatively, the vessel base is designed to include microwave transparent cooling coils 352 circulating microwave transparent coolant for temperature stabilization during processing and rapid cooling afterwards, as described above.

The embodiment of the present invention illustrated in FIG. 9 is denominated as a “stop-flow” device. In operation, turning the handle 304 and lifting the lid 302 open the chamber 310. The vessel is cleaned or replaced as necessary. As described above, a stirring structure 306 is snapped onto the stirring axle 308 and the sensors are positioned correctly. The lid 302 is closed and the handle 304 is turned until the safety interlock is set. The chamber pressure is increased to the desired processing value while the magnetron 322 is allowed to reach stable operation. Mixture is admitted into the chamber 310 through an inlet port 305 by a needle valve. Microwave power is modulated to maintain the mixture at the desired temperature or power time profile. After processing, either the mixture temperature is reduced sufficiently (below the mixture boiling point) by circulating coolant via the coolant inlet 351 in the coils or the mixture is forced out of the vessel through an outlet port controlled by a second needle valve and into a cooling vessel. For the outlet position shown in FIG. 9, a cam 355 automatically tilts the chamber 310 so that all the mixture drains out. More mixture is admitted and the process is repeated as desired. Alternately, the chamber pressure could be cycled in each process and the mixture admitted and discharged at near atmospheric pressure. Operation requires electrical (for example, 10 5 kW), high pressure gas (either inert or combined with reagents), and cooling water (e.g., 50 psi, 4 L/min, or a closed circuit chiller is used) utilities.

In either of the embodiments illustrated in FIGS. 7-8 or FIG. 9, pressure in the chamber (210,310) is controlled through a manifold similar to that shown schematically in FIG. 10. High pressure gas (gaseous reactants may be included) is admitted into the chamber (210,310) through one adjustable valve 510 while any excess pressure is released through a second constant pressure valve 512. If valve control is not fast enough to maintain sufficiently constant pressure, the chamber volume might be expanded to moderate fluctuations. To prevent catastrophic failure and release of the chamber contents outside, a reservoir 520 of sufficient volume is installed with a valve set 522,524 to release pressure into the reservoir (210,310) at some maximum safe value.

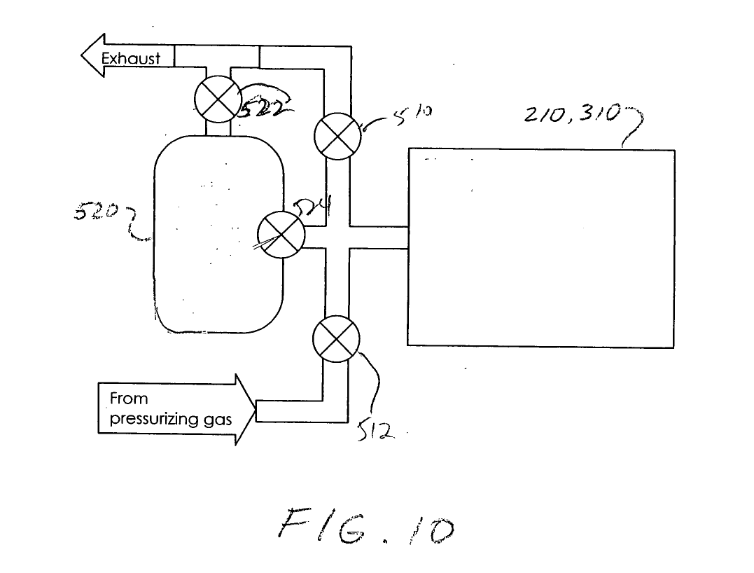

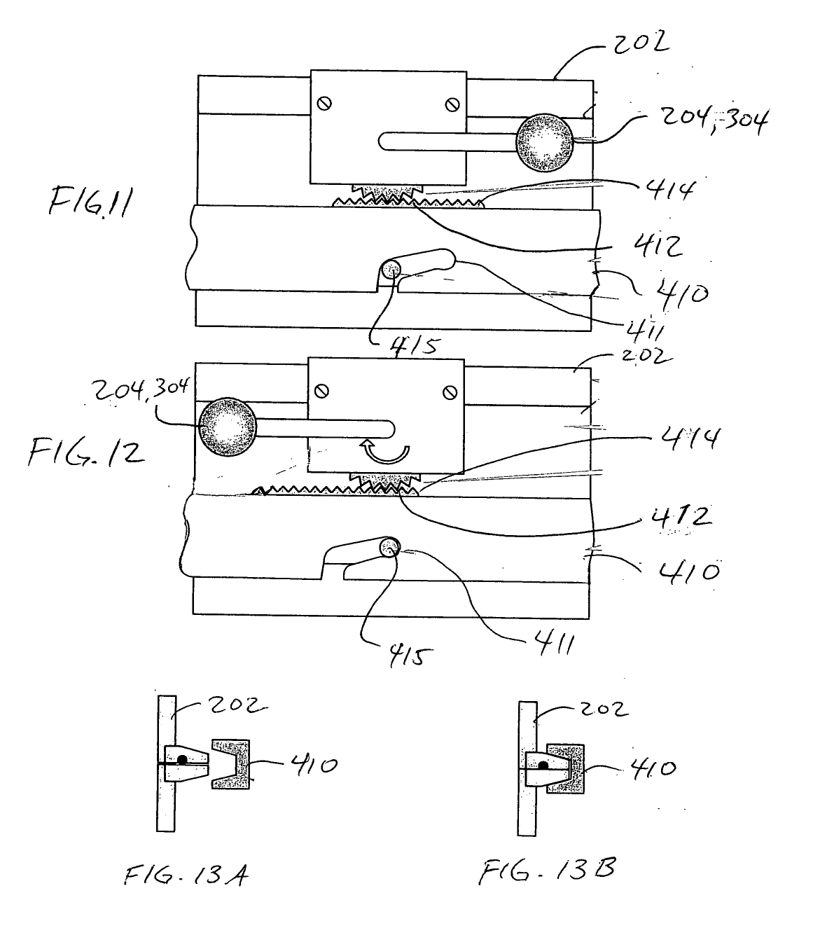

The chamber (210,310) in either of the embodiments illustrated in FIGS. 7-8 or FIG. 9 is preferably made in two halves: the upper lid is hinged to the lower, stationary bottom and can be lifted by a handle. A counterweight or spring is preferably provided to ease lifting and maintain an open position. When closed, an elastomer o-ring provides a pressure seal. The seal faces (“o-ring grooves”) on the lid and bottom flanges could be recessed to prevent damage. Clamping is preferably achieved by the apparatus shown in FIGS. 11 and 12. In one motion the lid is lowered and the handle (204,304) is turned, preferably about 180 degrees. A pinion gear 412 attached to the handle drives a rack 414 attached to a collar 410 encircling the chamber (210,310) and sitting on the lid flange. Notches 411 in the collar 410 admit pins 415 welded to the lower flange when the handle is in the open position. As the handle is turned, the collar 410 rotates about the chamber axis, causing the pins to slide into the notches. The notches 411 force the flanges together when the handle is in the closed position, forming a seal. A plastic gasket bearing between the collar and lid flange allows smooth motion of the collar. In an alternative scheme, clamping could also be done by a hinged ring clamp similar to that used in “Kwik-Flange” vacuum seals shown in FIGS. 13A and 13B, which illustrate respectively an unclamped and clamped ring.

In either of the embodiments illustrated in FIGS. 7-8 or FIG. 9, multiple ports in the chamber would flexibly allow various combinations diagnostic sensors.

In either of the embodiments illustrated in FIGS. 7-8 or FIG. 9, stirring is preferably accomplished by either mechanical or transducer coupling. In the case of a mechanical coupling could be accomplished as shown in FIG. 1 by extending a rigid, metal or microwave transparent rod from the motor fixed to the lid exterior, through the lid and barrier disk, which also serves as a bearing, and down to near the bottom of the vessel. A removable, microwave transparent stirring structure snaps onto the end of the rod and rotates when driven by the motor. This structure may be asymmetric to improve mixture homogeneity. The rotation rate and action (constant rotation, back-and-forth or possibly chaotic action) is adjustable and controlled by the user. In embodiments using transducers, the stirring apparatus is mounted in the base and driven at sonic or ultrasonic frequencies to agitate the mixture in the vessel. Fluid added between the base and vessel would enhance the coupling efficiency. The drive frequency is adjustable and controlled by the user. The individual transducers may be driven with controlled relative phases and frequencies that may not be constant to achieve more uniform global flow and mixing.

In either of the embodiments illustrated in FIGS. 7-8 or FIG. 9, Temperature is preferably controlled by modulating the microwave power in reaction to signals from one or more temperature sensors (fiber-optic) fed through the chamber lid and mounted in the barrier disk. For example, the sensors could be either (a) a remote sensing Exactus Optical Thermometer by BASF, or (b) model number FTP-ALO or FTP-PEEK probe offered by Photon Control of Burnaby, BC Canada. Because magnetron microwave sources require several minutes to stabilize, electronically controlled ferrite attenuators could be installed to provide essentially real-time repeatable power adjustment. As will be understood by those skilled in the art, many microwave-assisted reaction times are under one minute and accurate and dependable timing is therefore important.

In either of the embodiments illustrated in FIGS. 7-8 or FIG. 9, spectroscopic monitoring of the reaction progress is preferably implemented through optical fibers. For example, Photon-Control and Ocean Optics of Dunedin, Fla. (oceanoptics.com) offers very compact fiber coupled UV-Vis, Vis-NIR and Raman spectrometer systems for chemical analysis. Common practice in the industry is to use a Raman spectrometer from Enwave Optronics, Inc. (enwaveopt.com). RF spectroscopy may be utilized by modulating the microwave carrier or even introducing a separate signal in order to induce a response in the mixture that could be picked up by an antenna. Electromagnet coils could be incorporated in the chamber in order to induce nuclear magnetic resonance (NMR) signals for chemical identification. Alternatively, a small volume could be extracted continuously during processing and fed through an NMR unit for real time analysis of the process progress.

In either of the embodiments illustrated in FIGS. 7-8 or FIG. 9, Suitable microwave transparent materials may be PEEK (PolyEtherEtherKetone), Teflon, PTFE, Polyethylene, Polypropylene, Pyrex, quartz, sapphire, etc. PEEK is machinable, chemically inert and resistant, used in autoclaves, rated to 260 C, and survives 3000+ sterilization cycles.

In either of the embodiments illustrated in FIGS. 7-8 or FIG. 9, a reactor system could be equipped with the following diagnostic and control features.

Diagnostic:

Real-time sensing of the chamber pressure, mixture temperature (at one or more points preferably not to exceed ten), rate of stirring, delivered microwave power, and spectroscopy (UV-Vis absorption spectroscopy and Raman are recommended). All sensor information would be recorded at user defined intervals and displayed graphically and as text, in combination or separately. Microwave distribution would be certified so that absorbed microwave power density could be inferred. Data could be streamed to computer memory so that a record of all process conditions is available for future reference. Other possible diagnostic options might include a camera for imaging the vessel during processing.

Control:

The user control interface could consist of a ‘Prepare’, ‘Start’, and ‘Emergency Stop’ buttons and a keypad for entering all necessary parameters. The ‘Emergency Stop’ function is triggered if the handle is moved during processing (breaking an interlock), or pressure changes drastically, or the over-pressure valve opens, or coolant pressure drops, or any sensor malfunctions. The user could select the level and rate of change (1st derivative) of chamber pressure, mixture temperature (at one or more points), rate of stirring, and delivered microwave power over an essentially unlimited sequence of time intervals of arbitrary length. All of the diagnostic information would be used to control and stabilize the process conditions through PID algorithms. Pressure should not release rapidly.

From the comparison of diagnostic curves, internal energy released due to the chemical reaction itself could be distinguished from heating directly due to microwave energy absorption. Such a comparison would help in understanding the dynamics of processing and selection of optimal parameters.

Those skilled in the art will recognize that the various valves and ports, plus the probes for spectroscopy and other forms of monitoring permit controlling all the parameters of the reaction precisely. In particular, the various embodiments disclosed above allow for dynamic monitoring and real time adjustment to the flow of cooling fluids in conjunction and counterbalance with the amount of microwave energy emitted into the chamber. These capabilities and the capabilities to adjust pressure and the flow of the reaction mixture (in flow through designs) provides significant advantages. The embodiments of the present invention may be implemented with any combination of hardware and software. If implemented as a computer-implemented apparatus, the present invention is implemented using means for performing all of the steps and functions described above.

The embodiments of the present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. A microwave reactor for processing a flow of a mixture, said reactor comprising:
a reaction chamber having an unpressurized interior;
a reaction block disposed within the interior of the reaction chamber;
at least one antenna disposed within the interior of the chamber; and
at least one generator of electromagnetic radiation connected to the antenna,
wherein said flow may circulate through said reaction block,
wherein said generator generates a radiation that is uniformly and homogeneously propagated in the chamber and is evenly absorbed by the mixture.

2. The microwave reactor of claim 1, wherein the reaction chamber cross-section is symmetrical.

3. The microwave reactor of claim 2, wherein the reaction chamber is cylindrical and the chamber cross-section is circular.

4. The microwave reactor of claim 1, wherein the reactor comprises one antenna disposed on one side of the reaction block or two antennae disposed on opposite sides of a reaction block.

5. The microwave reactor of claim 1, wherein the reactor comprises an array of antennae disposed on one side of the reaction block

6. The microwave reactor of claim 1, wherein the reactor comprises at least two arrays of antennae disposed on opposite sides of a reactor block.

7. The microwave reactor of claim 1, wherein the reaction block is comprised of a solid section of material comprising one or more reaction channels within said solid section of material.

8. The microwave reactor of claim 7, wherein the reaction channels comprise one or more tubular channels.

9. The microwave reactor of claim 7, wherein the reaction block has a non-planar surface profile, chosen from the group consisting of concave or convex, wherein the surface profile is selected to refract the microwave field to produce a uniform within the reaction channels.

10. The microwave reactor of claim 7, further comprising a plurality of cooling channels disposed adjacent the reaction channels.

11. The microwave reactor of claim 1, wherein the reaction block is comprised of one or more tubes connected to a manifold .

12. The microwave reactor of claim 10, wherein the tubes are disposed entirely within the reaction chamber.

13. The microwave reactor of claim 1, wherein the reaction block comprises one or more inlets for admitting flow through a wall of the chamber.

14. . The microwave reactor of claim 1, wherein the reactor further comprises one or more computer controlled valves for regulating the operation of the reactor.

15. A microwave reactor for processing a batch of a mixture comprising:
an reaction chamber having an interior and a locking lid;
a reaction vessel disposed within the interior of the reaction chamber;
at least one antenna disposed within the interior of the chamber; and
at least one generator connected to the antenna,
wherein said generator generates a microwave radiation that is uniformly and homogeneously propagated in the chamber and is evenly absorbed by the mixture.

16. The microwave reactor of claim 15, wherein the reaction vessel is comprised of a vessel substantially conforming to the shape of the interior of the chamber.

17. The microwave reactor of claim 15, wherein the reactor further comprises a rigid disk barrier disposed between the lid and the reaction vessel, whereby when the lid is sealed, the reaction vessel is sealed.

18. The microwave reactor of claim 15, wherein the reactor comprises one antenna disposed on one side of the reaction vessel or two antennae disposed above and below a reaction vessel.

15. The microwave reactor of claim 10, wherein the reactor comprises one arrays of antennae disposed on one side of the reaction vessel

16. The microwave reactor of claim 10, wherein the reactor comprises at least two arrays of antennae disposed on opposite sides of a reactor block.

17. The microwave reactor of claim 10, wherein the reactor further comprises a cooling plate disposed beneath the reaction vessel.

18. The microwave reactor of claim 10, further comprising a stirring device extending into the reaction vessel.

19. The microwave reactor of claim 10 further comprising a mixture inlet valve, whereby the reaction vessel is filled via operation of the mixture inlet valove.

20. The microwave reactor of claim 18, further comprising a pressurizing gas inlet.
